(19) United States
(12) Patent Application Publication
(10) Pub. No.: US 2021/0120411 A1
(43) Pub. Date: Apr. 22, 2021

(54) METHOD FOR OBTAINING A PROFILE FOR ACCESS TO A TELECOMMUNICATIONS NETWORK

(71) Applicant: ORANGE, Paris (FR)

(72) Inventors: Said Gharout, Chatillon Cedex (FR); Charles Hartmann, Chatillon Cedex (FR)

(21) Appl. No.: 16/472,585

(22) PCT Filed: Dec. 11, 2017
(86) PCT No.: PCT/FR2017/053491

§ 371 Date: Jun. 21, 2019

(30) Foreign Application Priority Data
Dec. 23, 2016 (FR) 1663295

(51) Int. Cl. H04W 12/069; H04W 12/04; H04W 8/20

(52) U.S. Cl. CPC H04W 12/069; H04W 84/042; H04W 8/205; H04W 12/04

(57) ABSTRACT

A method for obtaining a profile for access to a telecommunications network by a mobile equipment. The method includes: sending by the mobile equipment to a network entity a request for accessing the network, the request including an initial subscriber identifier included in an initial profile; mutual authentication between the mobile equipment and the network entity by using an initial secret key associated with the initial identifier; and receiving from the network entity a new profile for access to the network, the new access profile including a new subscriber identifier and a new secret key, the new profile being configured for accessing the network.

### CROSS-REFERENCE TO RELATED APPLICATIONS

This application is a Section 371 National Stage Application of International Application No. PCT/FR2017/053491, filed Dec. 11, 2017, the content of which is incorporated herein by reference in its entirety, and published as WO 2018/115634 on Jun. 28, 2018, not in English.

### FIELD OF THE DISCLOSURE

The invention relates to the field of telecommunications.

It relates more particularly to a method for obtaining a profile for access to a mobile network from a mobile equipment.

### BACKGROUND OF THE DISCLOSURE

In order to access a mobile network, a subscriber must dispose of an application on their mobile equipment for accessing the network and associated data. These elements are referred to as “operator credentials”, or “operator profile”, or “profile for access to the network”. They comprise data such as a subscriber identifier, generally denoted by “IMSI” (for “International Mobile Subscriber Identity”), and a secret key, denoted Kᵢ key for 2G networks and K key for the 3G and 4G networks, the knowledge of which is shared between the nominal mobile network, or “HPLMN” (for “Home Public Land Mobile Network”), or “home” network of the subscriber, and a security module of the subscriber card type, included in the mobile equipment.

Using the common key K/Kᵢ, operator parameters, an authentication algorithm, for example Milenage, and a security architecture defined by the 3GPP body, the subscriber is authenticated by the operator of the nominal network responsible for the subscription when they access the nominal network or a network they are visiting.

Thus, in order to access a mobile network, the subscriber must dispose of an access profile associated with a subscription to which they have subscribed. Failing this, they will not obtain access to the network, apart from emergency calls, according to the regulations of the country they are visiting.

In the case of a conventional removable security module, of the UICC type, generally referred to as a “SIM” (for “Subscriber Identity Module”) card, the profile of the operator is usually installed on the security module prior to acquisition of the mobile equipment by the subscriber. In the case of an onboard security module of the “eUICC” (for “embedded UICC”) type, or fixed SIM card, the profile may be installed prior to acquisition of the equipment by a user or later on, once the mobile equipment is in the possession of the user. In the latter case, the user of the mobile equipment can order, via an interface of the mobile equipment after taking out a subscription on a gateway of the operator, or when they subscribe in a store of the operator or of a retailer, the download of the access profile prepared by the operator for this subscriber onto the security module. This mode of operation offers a certain flexibility for an initial subscription, or when there is a change of operator. The access profile prepared by the operator when the subscription is taken out is then sent to the security module over an Internet link of the mobile equipment, or through the connectivity of an existing operator, when a profile associated with a previous operator is replaced. More precisely, a local profile manager, or LPA (for “Local Profile Assistant”) installed on the mobile equipment acquires the profile from the operator via the Internet connection and installs it on the eUICC card included in the equipment. After installation of the access profile on the security module, the latter is activated. The subscriber can then be authenticated by the operator of the mobile network for access to the network of this operator and to the associated services. It should be noted that the security module is authenticated by virtue of a card certificate containing its EID (for “eUICC Identifier”) physical identifier. This allows the operator to create an access profile which is intended solely for this card, to the exclusion of any other, in the framework of particularly secure procedures.

In both cases, in other words in the case of a conventional security module of the SIM card type or in the case of a module of the eUICC card type, the profile corresponding to a subscription which has been previously taken out with an identified operator must be installed on the security module prior to any access to the network. Either the profile is previously installed, or an existing cellular connectivity or the Internet must be available in order to allow the installation of the profile.

Currently, no procedure is defined that allows access to any given mobile network and to the associated services without prior possession of an access profile created for the subscriber.

### SUMMARY

One of the aims of the invention is to overcome the shortcomings/drawbacks of the prior art and/or to bring improvements to it.

For this purpose, the invention provides a method for obtaining a profile for access to a telecommunications network by a mobile equipment, the method comprising:
sending by the mobile equipment to a network entity of a request for accessing said network, said request comprising an initial subscriber identifier included in an initial profile,
mutual authentication between the mobile equipment and the network entity by means of an initial secret key associated with the initial identifier,
receiving from the network entity a new profile for access to said network, said new access profile comprising a new subscriber identifier and a new secret key, said new profile being configured for accessing said network.

The method offers the possibility of obtaining a profile for access to a mobile network from an operator, without initially having an existing connectivity with another operator, or an Internet access, available for receiving the access profile. The mobile equipment disposes of initial operator data (or “credentials”) which constitute an initial profile and which allow a first access to the mobile network of the operator limited to the acquisition of a new profile associated with a subscription. The new profile is an operational and permanent profile in the sense that it allows the subscriber access to the network of the operator and to the associated services as a client.

Furthermore, the method does not require the existing network architecture to be modified and/or a specific interface to be defined for accessing the mobile network. It is down to the operator to make a dedicated configuration (or “provisioning”) network available.

In one exemplary embodiment, when no subscription has previously been taken out by a user of the mobile equipment with an operator associated with the network entity, the method comprises:
receipt of a message, said message comprising the address of a site of the operator, said site being dedicated to taking out subscriptions,
access to the site and taking out a subscription with the operator associated with the network entity, said subscription being used by the operator to generate the access profile.

In this exemplary embodiment, the user of the mobile equipment has not yet taken out a subscription with the operator. The first access to the network allows them to access a gateway of the operator dedicated to taking out a subscription.

In another variant embodiment, when no subscription has previously been taken out by a user of the mobile equipment with an operator associated with the network entity, the method comprises:
receiving a telephone call from the operator,
taking out a subscription with the operator associated with the network entity, said subscription being used by the operator to generate the access profile.

This example constitutes a variant of the preceding example in the sense that the subscription is done over the telephone.

In one exemplary embodiment, the initial identifier comprises at least one field representative of an access limited to the acquisition of a profile for access to the network.

In this example, the initial identifier of the initial profile has a generic format, in the sense that it comprises one or more specific fields. For example, the initial identifier comprises an MCC country code field equal to “000”, not currently used in the E212 identification plan of the UIT-T (for “Union Internationale des Télécommunications—Telecommunications sector”), or the combination of an assigned MCC country code field, for example “901”, currently shared by transnational networks and a non-assigned MNC national network code field, for example “00”. This generic format of initial identifier allows the operator who receives the request for attachment to the network to implement the appropriate processing corresponding to an access limited to the acquisition of an operational access profile.

In another exemplary embodiment, the initial identifier is read by means of the mobile equipment on a ticket supplied by the operator, said ticket comprising an identifier of a security module included in the mobile equipment.

This example allows the need for the installation of the initial profile to be obviated, which profile comprises the initial identifier and the initial secret key, at the time of the production of the security module by a manufacturer of modules. Furthermore, the operator already knows this initial key or possesses the means for calculating it based on the initial identifier.

This exemplary embodiment is advantageous in the sense that the operator obviates the need for a prior agreement with the manufacturer of security modules for the prior injection of initial data into the modules. Here, it is the operator who supplies this initial data. Furthermore, the operator controls the association between an initial profile and a security module by associating the ticket with the identifier of the security module. Thus, the profile for access to the operational network generated after the first access to the network by means of the initial profile is only sent to the security module whose module identifier coincides with the identifier appearing on the ticket. This enhances the security of the method for obtaining a profile for access to the network.

The invention also relates to a method for supplying a profile for access to a telecommunications network by a network entity to a mobile equipment, the method comprising:
receiving from a mobile equipment a request for access to the network, said request comprising an initial subscriber identifier included in an initial profile,
mutual authentication between the network entity and the mobile equipment by means of an initial secret key associated with the initial identifier,
sending to the mobile equipment a new profile for access to the network, said new access profile comprising a new subscriber identifier and a new secret key, said new profile being configured for accessing said network.

The invention also relates to a mobile equipment comprising:
transmission means, configured for sending a request for access to the network, said request comprising an initial subscriber identifier included in an initial profile,
authentication means, configured for implementing a mutual authentication with the network entity by means of an initial secret key associated with the initial identifier,
receiving means, configured for receiving from the network entity a new profile for access to the network, said new access profile comprising a new subscriber identifier and a new secret key, said new profile being configured for accessing said network.

The invention also relates to a program for a mobile equipment, comprising program code instructions designed to control the execution of the steps of the method for obtaining a profile for access to a network such as previously described, when the program is executed on said device.

The invention also relates to a data medium in which the aforementioned program is recorded.

The invention also relates to an equipment of a telecommunications network, configured for supplying a profile for accessing the network to a mobile equipment, said equipment comprising:
reception means, configured for receiving from the mobile equipment a request for access to the network, said request comprising an initial subscriber identifier included in an initial profile,
authentication means, configured for implementing a mutual authentication with the mobile equipment by means of an initial secret key associated with the initial identifier,
transmission means, configured for sending a new profile for access to the network to the mobile equipment, said new access profile comprising a new subscriber identifier and a new secret key, said new profile being configured for accessing said network.

The invention also relates to a program for a network equipment, comprising program code instructions designed to control the execution of the steps of the method for supplying a profile for access to a network such as previously described, when the program is executed on said entity.

The invention also relates to a data medium in which the aforementioned program is recorded.

The invention also relates to a system for distribution of profiles for access to a telecommunications network comprising:
a network equipment such as previously described,
at least one mobile equipment such as previously described.

### BRIEF DESCRIPTION OF THE DRAWINGS

Other features and advantages of the present invention will be better understood from the description and from the appended drawings amongst which:

FIG. 1 shows the steps of a method for obtaining a profile for access to a mobile network, according to a first exemplary embodiment;

FIG. 2 shows the steps of a method for obtaining a profile for access to a mobile network, according to a second exemplary embodiment;

FIG. 3 is a schematic representation of a mobile equipment able to implement the method for obtaining a profile for access to a mobile network, according to one exemplary embodiment;

FIG. 4 is a schematic representation of network equipment able to implement the method for obtaining a profile for access to a mobile network, according to one exemplary embodiment.

### DETAILED DESCRIPTION OF ILLUSTRATIVE EMBODIMENTS

The steps of a method for obtaining a profile for access to a mobile network from a mobile equipment, according to a first exemplary embodiment, will be described with reference to FIG. 1.

In the exemplary embodiment described here, a user (not shown) possesses a mobile equipment 10, such as a mobile terminal, a tablet, etc. The mobile equipment 10 comprises a security module 101 or subscriber card, such as an “eUICC” (for “embedded UICC”) card, designed to contain an operator profile, or access profile, in order to access a mobile network. The operator profile, prepared by an operator for a subscriber when they take out a subscription with this operator, is designed to be used by this subscriber when they access the network of this operator and associated services. For the subscriber, the network of the operator with whom they take out the subscription is referred to as nominal network, or “home network”, or “HPLMN” (for “Home Public Land Mobile Network”).

The operator profile comprises operator data such as a subscriber identifier understandable by the network and generally denoted “IMSI” (for “International Mobile Subscriber Identity”), a secret key denoted “K” in 3G and 4G networks, and “Kᵢ” in 2G networks, shared between the security module 101 and the network of the operator, an authentication algorithm, for example Milenage or Tuak, parameters and potentially applications specific to the operator, for example a payment application. In the following, the secret key is called “K key”, independently of the type of mobile network in question. A mobile telecommunications network, such as a network of the 3G or 4G type, is represented schematically in FIG. 1 by a network entity 11.

It should be noted that, in order to access a mobile network, a subscriber must possess operator data, or “operator credentials”, which comprise a subscriber identifier, a secret key K shared with the nominal network of the subscriber, in other words the network with which the subscription has been taken out, and parameters specific to the authentication algorithm used for accessing the network.

The method for obtaining a profile for access to a mobile network is described here in the framework of a network of the 4G LTE (for “Long Term Evolution”), LTE-Advanced, or LTE-Advanced Pro type. The invention is not however limited to this type of network and is also applicable to other types of mobile networks such as for example a GPRS (for “General Packet Radio Service”) or UMTS (for “Universal Mobile Telecommunications System”) network.

It is assumed that, initially, the user has their mobile equipment 10 available but that they do not yet have a profile for access to the network associated with a subscription of a particular operator installed in their security module 101 allowing them access to the mobile network of this operator and the associated services. The particular operator is the one who is associated with the network represented schematically by the network entity 11. In this exemplary embodiment, it is assumed that the user has taken out a subscription with the operator by for example going into an outlet of this operator. The operator has generated a profile for access to the associated network which is not yet installed on the security module 101. It is furthermore assumed that the mobile equipment 10 does not have any alternative connectivity, in other words that it does not have any active subscription with another operator or Internet connectivity for installing a profile corresponding to a subscription to which it is subscribed.

It is recalled that a subscriber identifier of the IMSI type comprises several fields:
a country code, or “MCC” for “Mobile Country Code”; for example, MCC=208 corresponds to mainland France,
a network code, or “MNC” for “Mobile Network Code”; for example, MNC=01 corresponds to the operator Orange™,
a subscriber identification number, or “MSISDN” for “Mobile Station ISDN Number”. This is a number from the E.164 dial plan which corresponds to the international number of the subscriber.

In a preliminary state (not shown in FIG. 1) corresponding for example to the acquisition of the mobile equipment 10 by the user, it is assumed that the security module 101 comprises an initial profile comprising an initial subscriber identifier IMSIᵢₙᵢₜ, for example of the IMSI type, an initial secret key denoted Kᵢₙᵢₜ of an authentication algorithm and parameters of the authentication algorithm. The initial profile has been installed on the security module 101 during its manufacture. For example, an agreement has been drawn up between a manufacturer of security modules responsible for the module 101 and one or more mobile network operators, including the operator managing the network entity 11, in order for the initial identifier IMSIᵢₙᵢₜ included in the initial profile installed by the manufacturer to be considered as a partner identifier of the operator(s). This initial profile is intended to obtain a first restricted connectivity to the operator. “Restricted” means that this connectivity only allows a second profile for access to the network of the operator to be obtained. This restricted access corresponds to an access to a configuration (or “provisioning”) network, or a subscription management network. The second access profile is a permanent and conventional access profile in the sense that it allows access to the network of the operator and to associated services, such as a mobile Internet access, a voice access, an SMS/MMS (for “Short/Multimedia Message Service”) access, etc., as a client of this operator. It corresponds to the subscription taken out by the user.

In the exemplary embodiment described here, the initial profile is a generic profile in the sense that it is not associated with any particular operator. For example, the initial identifier IMSIᵢₙᵢₜ comprises an MCC country code=000 which is currently not used. In another exemplary embodiment, the initial identifier IMSIᵢₙᵢₜ comprises an MCC country code=901 which is currently shared by transnational networks and an MNC network code=00 which is not currently used. Such a value is intended to allow the network operator, who receives a request for attachment to the network which comprises such an identifier, to process the request for access as a request to obtain an access profile associated with a permanent subscription and to limit this access to a provisioning network dedicated to the acquisition and to the activation of the permanent access profile.

In an initial step E10, the user tries to access the mobile network. For example, they turn on their mobile equipment 10. The mobile equipment 10 then sends out a request for attachment to the network over the wireless channel. The request for attachment comprises an identifier of the user equipment 10, in this case the initial identifier IMSIᵢₙᵢₜ stored in the security module 101.

The request for attachment is received by the network entity 11 in a reception step E11.

In a following analysis step E12, the network entity 11 analyzes the initial identifier IMSIᵢₙᵢₜ received. It identifies that it is an initial identifier associated with an initial profile owing to the value of the specific MCC country code, or of the specific combination MCC country code and MNC national network code.

In a step E13 for identification of the associated initial secret key, the network entity 11 obtains the initial secret key Kᵢₙᵢₜ associated with the initial identifier IMSIᵢₙᵢₜ. In a first exemplary embodiment, the network entity 11 calculates the initial secret key Kᵢₙᵢₜ by applying a key derivation algorithm “KDF” (for “Key Derivation Function”) to a master key “MK” and to the initial identifier IMSIᵢₙᵢₜ received in the request for attachment. Thus, Kᵢₙᵢₜ=KDF(MK, IMSIᵢₙᵢₜ) In one exemplary embodiment, the key derivation function KDF is the “AES” (for “Advanced Encryption Standard”) algorithm. In a second exemplary embodiment, the key derivation function KDF is the algorithm PBKDF2 such as defined in the RFC2898 (for “Request For Comment”). In another exemplary embodiment, the key derivation function KDF is a hashing function with secret key of the authentication message “HMAC” (for “Keyed-Hashed Message Authentication Code”) type.

It is of course assumed that the initial secret key Kᵢₙᵢₜ injected by the manufacturer of security modules into the module 101 has been calculated in the same way.

In a second exemplary embodiment, a partner database stores the initial keys, in association with the initial identifiers and/or operator parameters. In this case, the network entity 11 accesses the partner database in order to acquire the initial secret key Kᵢₙᵢₜ associated with the initial identifier IMSIᵢₙᵢₜ.

In a following authentication phase P14 (not detailed), the procedure for attachment to the network goes ahead and an authentication between the mobile equipment 10, more precisely the security module 101, and the network entity 11 is implemented, conforming to the registration procedure such as described for example in the specification 3GPP TS 23.401. At the end of this phase, the mobile equipment 10 is authenticated and keys for encryption of the wireless channel and for verifying integrity, respectively denoted CK and IK, and specific to the mobile equipment 11 have been derived from the initial secret key Kᵢₙᵢₜ. It should be noted that the registration procedure described in the specification 3GPP TS 23.401 specifies a mutual authentication between the mobile equipment 10 and the network entity 11. In the case of a 2G network, the authentication is unilateral in the sense that only the mobile equipment 10 is authenticated by the network entity 11.

In a following step E15 for sending and for activating the profile, the network entity 11 sends the profile for access to the network of the operator associated with the subscription taken out by the user. The access profile, prepared by the operator at the time of the subscription, comprises data specific to the subscriber as a client and designed to allow the access to the network of the operator and to the associated services from the mobile equipment 10. The access profile comprises a new IMSI identifier specific to the subscriber, an associated new secret key K, operator parameters specific to the authentication algorithm and potentially applications of the operator. The access profile is sent by the network entity 11 using the encrypted wireless channel. This profile replaces the initial profile in the security module 101.

The profile for access to the network is received and automatically activated in a following reception and activation step E16. In a first variant embodiment, the network entity 11 sends the access profile then an explicit command for activation of said profile to the mobile equipment 10. In a second variant embodiment, it is the user who commands the activation of the access profile once the latter has been received. The initial identifier IMSIᵢₙᵢₜ and the initial secret key Kᵢₙᵢₜ stored in the security module 101, are eliminated and replaced by the new IMSI identifier and the new secret key K. This exemplary embodiment corresponds to a case where the security is based entirely on the security of the wireless channel inherent to the encryption of the wireless channel using the encryption key CK generated during the authentication phase P14 for encrypting the voice or the data.

It should be noted that the exemplary embodiment described integrates perfectly into an existing mobile network architecture. Indeed, it does not need any modification of the interface with the mobile network. For example, it does not require the procedure for attachment to the network to be modified.

In a following update step E17, the network entity 11 deletes the initial identifier IMSIᵢₙᵢₜ and, where relevant, the associated initial secret key Kᵢₙᵢₜ in its partner database. In another exemplary embodiment, the initial data are transferred into a second database which comprises the initial data already used; this second database is consulted by the operator when new requests for attachment to the network are received. For security reasons, it is considered that such initial access data are only usable once. An attempt to access the network using initial data already used is detected by the operator. The operator can thus pre-empt potential attacks during which cards containing identifiers and initial secret keys might be cloned and used to obtain permanent access profiles.

In a following phase for access to the network (not shown in FIG. 1), during which the user wishes to access the mobile network of the operator, the mobile equipment 10 sends a second request for attachment to the network. This second attachment request comprises the new IMSI identifier which is included in the operational profile obtained during the implementation of the preceding steps.

In the exemplary embodiment described with reference to FIG. 1, it is assumed that the subscription has already been taken out by the subscriber. In another exemplary embodiment, the user has not yet taken out any subscription. A permanent operator profile specific to a subscription has not therefore been created by the operator for the subscriber. In this case, once the authentication of the security module 101 has been implemented during the authentication phase P14, the network entity 11 sends a “URL” (for “Uniform Resource Locator”) to the user for access to a gateway of the operator reserved when subscriptions are taken out. This is sent via a network access point, or “APN” (for “Access Point Name”), dedicated to the operator and offering a restricted connectivity, but allowing an access for taking out subscriptions. This may be sent by means of an SMS. In another exemplary embodiment, the subscriber is called by the operator. The subscriber supplies the information needed for the subscription. An access profile is then generated by the operator and transmitted to the mobile equipment over the encrypted channel of the wireless channel, according to the step E15 for transmission of the profile. This access profile replaces the initial profile in the security module 101.

The invention has been described in the case of an eUICC security module of the client, or “consumer equipment”, type. The invention is not limited to this type of module and, in another exemplary embodiment, the security module is an “M2M” (for “Machine To Machine”) eUICC module. In this case, if the M2M equipment does not possess a user interface, it is necessary for an M2M subscription to have been acquired by an M2M equipment manager for the mobile equipment 10, prior to the access to the network for obtaining the subscription profile. Thus, in the step E15 for sending the profile, the profile for access to the network is sent by the network entity 11 via the encrypted wireless channel, the data streams being fully protected or by application.

The method is not limited to a security module of the eUICC type and, in another exemplary embodiment, the security module is a conventional UICC security module of the SIM card type. The method is identical to that previously described and is also applicable to mobile devices of the client equipment and M2M equipment type.

In the exemplary embodiments previously described, the initial identifier IMSIᵢₙᵢₜ, or the initial secret key Kᵢₙᵢₜ or the means of generating it, are already present in the security module 101 when the user acquires their mobile terminal 10. The initial identifier IMSIᵢₙᵢₜ, or the initial secret key Kᵢₙᵢₜ, have indeed been installed by the manufacturer during the manufacture of the security module 101.

In another exemplary embodiment (not shown in FIG. 1), none of this data, in other words the initial identifier IMSIᵢₙᵢₜ or the initial secret key Kᵢₙᵢₜ, is present in the security module 101 when the mobile equipment 10 is acquired by the user. In this case, when a subscription is taken out with the operator or when the mobile equipment 10 is acquired by the user, the operator generates an initial identifier IMSIᵢₙᵢₜ and an associated initial secret key Kᵢₙᵢₜ. The operator also generates a ticket of the QR Code (for “Quick Response Code”) type which comprises the initial identifier IMSIᵢₙᵢₜ, the initial secret key Kᵢₙᵢₜ, an identifier of the network of the operator of the “HPLMN” (for “Home Public Land Network”) type and potentially operator parameters. In one exemplary embodiment, the ticket generated also comprises a physical identifier ID of the security module 101, which is stored in memory in association with the initial identifier IMSIᵢₙᵢₜ and the initial secret key Kᵢₙᵢₜ that it has generated. The physical identifier ID of the security module 101 is of the ICCID (for “Integrated Circuit Card ID”) type in the case of a module of the UICC type, and the EID (for “eUICC Identifier”) type in the case of a security module of the eUICC type. The ticket generated is for example glued onto the packaging of the mobile equipment 10, or sent to the user, or purchased in a supermarket. When the user wishes to access the network in order to obtain a profile for access to the network, they flash the ticket by means of their mobile equipment 10 in order to read the data from the ticket including initial identifier IMSIᵢₙᵢₜ and the initial secret key Kᵢₙᵢₜ. For example, the data read on the ticket is transmitted by a local profile manager of the “LPA” (for “Local Profile Assistant”) type of the mobile equipment 10 to the security module 101. Once the initial profile has been installed on the security module, the steps previously described are implemented in order to install the profile for access to the network in the mobile equipment 10. The presence of an HPLMN identifier of the network of the operator allows it to be indicated to which network the mobile equipment 10 is to be connected. In one variant embodiment implemented, if a subscription has already been taken out, the local profile manager of the mobile equipment 10 obtains the profile for access to the network from the network entity 11 by supplying the identifier ID of the security module. In this case, the operator has added information into the ticket such as an address or a name of the profile server to be contacted. Such a server is called SM-DP+(for “Subscription Manager—Data Preparation”) in the case of an eUICC security module of the “consumer equipment” type complying with the implementation described in the specification GSMA SGP.22. The use of a ticket for obtaining the initial data then the profile for access to the network is advantageous in the sense that the operator obviates the need for a prior agreement with the manufacturer of security modules for the prior injection of initial data into the security module. It should be noted that, in this case, the initial identifiers do not need to comply with a particular format; they are specific to the operators.

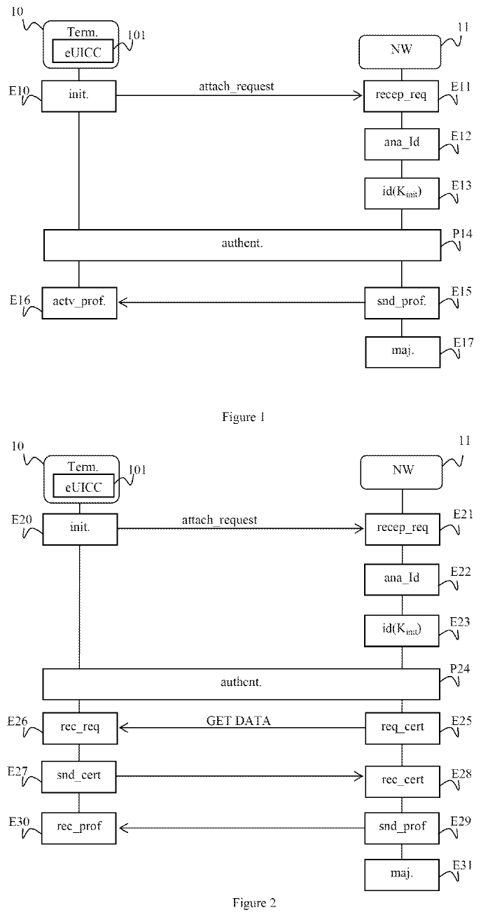

The steps of a method for obtaining a profile for access to a mobile network by a mobile equipment, according to a second exemplary embodiment, will now be described with reference to FIG. 2.

In this exemplary embodiment, an initial profile is also used for accessing the network in order to obtain a permanent access profile, associated with a subscription. In this example, the transmission of the profile for access to the network to the mobile equipment 10 is made secure by predefined procedures based on a certificate specific to the security module. The installation of the permanent access profile on the security module 101 is then carried out by means of secure procedures based on this certificate, independently of the security inherent in the encryption of the wireless channel.

It is assumed that the security module 101 of the mobile equipment 10 is a client module, or “consumer equipment” of the eUICC type. It comprises an initial profile comprising an initial subscriber identifier IMSIᵢₙᵢₜ and an initial secret key Kᵢₙᵢₜ. The way of obtaining this profile is identical to that previously described and carried out for example subsequent to an agreement being established between a manufacturer of security modules and one or more operators. The type of profile is also identical to that previously described.

In an initial step E20, the user turns on their mobile device in order to access the network. The device generates and sends a request for attachment to the network which comprises the initial subscriber identifier IMSIᵢₙᵢₜ.

The request is received in a reception step E21.

In an analysis step E22, the network entity 11 analyzes the initial identifier IMSIᵢₙᵢₜ. It identifies that it is an initial identifier associated with an initial profile, owing to the value of the specific MCC country code, or of the specific combination MCC country code and MNC national network code.

In a step E23 for identification of the initial secret key, the network entity 11 obtains the initial secret key Kᵢₙᵢₜ associated with the initial identifier IMSIᵢₙᵢₜ. In a first exemplary embodiment, the network entity 11 calculates the initial secret key Kᵢₙᵢₜ by applying a key derivation algorithm KDF to a master key MK and to the initial identifier IMSIᵢₙᵢₜ. In a second exemplary embodiment, the network entity 11 extracts from a partner database, to which it has access, the initial secret key Kᵢₙᵢₜ stored in memory in association with the initial identifier IMSIᵢₙᵢₜ.

In a following authentication phase P24, the attachment procedure continues and an authentication phase between the mobile equipment 10, more precisely the security module 101, and the network entity 11 is implemented in a known manner according to the registration procedure such as described for example in the specification 3GPP TS 23.401. When this procedure has finished, the mobile equipment 10 is authenticated by the network entity 11 and keys for encryption of the wireless channel and for verifying integrity, denoted CK and IK, have been derived from the initial secret key Kᵢₙᵢₜ.

In a following information request step E25, the network entity 11 requests the certificate of the security module 101 from the mobile equipment 10. For this purpose, the network entity 11 sends a request GET DATA to the mobile equipment 10 such as for example defined by the GlobalPlatform association. The request is received by the mobile equipment 10 in a reception step E26.

In a reply step E27, the mobile equipment 10 sends the certificate of the security module 101. In the exemplary embodiment described here, where the security module 101 is a module of the client module or “consumer equipment” type, the certificate is of the form: CERT.EUICC.ECDSA. The certificate of the security module 101 is received by the network entity 11 in a reception step E28.

In a first exemplary embodiment, where it is assumed that a subscription has been taken out by the user of the mobile equipment 10 and that an associated profile has been generated by the operator, in a step E29 for sending the profile and for activation, the network entity 11 sends the access profile to the security module 101 via the mobile equipment 10 according to the specification GSMA SGP.22 which describes an architecture for the remote provision of a profile to a security module (or “RSP” for “Remote SIM Provisioning”).

In a following reception and activation step E30, the profile for access to the network is received by the security module 101 and automatically activated. It is substituted for the initial profile used for the first access to the network. For example, in the case of an eUICC module, the initial profile is disabled and the access profile received becomes the active profile. In one variant embodiment previously described, the network entity 11 sends an explicit command for activation to the security module 101 via the mobile equipment 10. In another variant embodiment, it is the user of the mobile equipment 10 who explicitly activates their profile for access to the network.

In a following update step E31, the network entity 11 deletes the initial identifier IMSIᵢₙᵢₜ and, where appropriate, the associated initial secret key Kᵢₙᵢₜ from its partner database. In another exemplary embodiment, the initial data IMSIᵢₙᵢₜ and Kᵢₙᵢₜ are transferred into the second database which comprises the initial data already used in order to verify that these initial data are only used once.

In a second exemplary embodiment, it is assumed that no subscription has yet been taken out by the subscriber. In this case, prior to the step E29 for sending the access profile, the network entity 11 sends a URL to the mobile equipment 10, which comprises a link to a gateway of the operator dedicated to taking out subscriptions with this operator. The URL is sent via SMS. As previously described, the user selects the link and proceeds with the subscription. The operator generates the subscription based on the information supplied by the user and, during the step E29, sends the profile generated such as previously described. In one variant embodiment, instead of sending a link to a subscription site, the operator calls the subscriber in order to do the subscription by telephone. In another exemplary embodiment, the user has an application on their mobile equipment for doing the subscription.

The invention has been described in the case of an eUICC security module of the client type, or “consumer equipment” type. The invention is not however limited to this type of module and, in another exemplary embodiment, the security module is an M2M eUICC module. As previously stated, if the mobile equipment does not possess a user interface, it is necessary for an M2M subscription to have been taken out by an M2M equipment manager for the mobile equipment 10, prior to the access to the network with the intention of obtaining the profile for access to the network. Thus, in the step E29 for sending the profile, the profile for access to the network is sent by the network entity 11 according to the specification GSMA SGP.02, specific to the M2M equipment. It should be noted that, in this case, the certificate of the security module is of the form: CERT.EUICC.ECKA.

The second exemplary embodiment has been described in the case of a security module 101 of the eUICC type for a client module, or “consumer equipment”, and for an M2M module. The invention is not limited to these examples. Thus, the invention is also applicable to a conventional UICC security module of the SIM card type. However, in this case, the transmission of the access profile differs slightly from that described with reference to FIG. 2. Thus, it is assumed that a subscription has been taken out by the user and that a profile has been generated by the operator. It is assumed that this profile is stored by the operator and accessible by the network entity 11 and that this profile is encrypted by the operator by means of a profile random encryption key K_{rand}.

In the information request step E25, the network entity 11 sends a request GET DATA intended to obtain the certificate of the security module 101. In the step E27, the mobile equipment 10 sends the certificate of the security module 101 in response.

In a following step (not shown in FIG. 2), the network entity 11 obtains the certified public key Pk_{UICC} of the security module 101 which appears in the certificate of the security module 101. In a following step for sending the profile random encryption key K_{rand}, the network entity 11 sends the profile random encryption key K_{rand}, encrypted by means of the public key Pk_{UICC}. In a following step, the network entity 11 sends the encrypted access profile. The mobile equipment 10, more precisely the security module 101, decrypts the profile random encryption key K_{rand} by means of its private key associated with the certified public key and decrypts the profile by means of the profile random encryption key K_{rand}. This mode of obtaining the profile conforms to the GlobalPlatform model “PushModel”.

In one variant embodiment, conforming to the GlobalPlatform SCP 11 (for “Secure Channel Protocol”) model, once the network entity 11 has received the certificate for the public key of the security module 101, the network entity 11 and the mobile equipment 10, more precisely the security module 101, calculate a common session key Kₛₑₛₛ according to a known protocol, for example a Diffie-Hellmann protocol. The generated session key Kₛₑₛₛ is subsequently used by the network entity 11 for encrypting the access profile and sending it to the security module 101 via the mobile equipment 10. In a second variant embodiment where the access profile is already encrypted with the profile random encryption key K_{rand}, the session key Kₛₑₛₛ is used for encrypting the profile random encryption key K_{rand}.

In another exemplary embodiment, corresponding to the case where the initial data comprising the initial identifier IMSIᵢₙᵢₜ, the initial key Kᵢₙᵢₜ and the physical identifier ID of the security module 101 are inserted by the operator into a ticket which is flashed by the mobile equipment 10, the operator uses the physical identifier ID to make the installation of the operational profile for access to the network secure. The operator thus verifies that the profile for access to the network generated after the first access to the network by means of the initial profile is only sent to the security module 101 whose module identifier, appearing in the certificate of the security module, coincides with that which it has stored in association with the initial data and recorded in the ticket that it has generated. For this purpose, the network entity 11 requests from the mobile equipment 10, during the information request step E25, the physical identifier ID of the security module 101. For this purpose, it sends a request GET DATA such as defined for example by the GlobalPlatform association. It receives the physical identifier of the security module 101 in the reply step E27. The network entity 11 then verifies that the physical identifier that it has received is the same as the identifier ID that it has recorded and inserted into the ticket prior to sending the access profile during the profile transmission step E29. This offers an additional security for the operator. In this way, the operator makes secure upstream the later installation of the profile for access to the network by inserting into the ticket the physical identifier ID of the security module 101.

In one variant embodiment, a ticket is created which comprises the initial data IMSIᵢₙᵢₜ, Kᵢₙᵢₜ, the physical identifier ID of the security module 101 and an IP address of a server of the operator who generates and/or makes available profiles for accessing the network that it generates after taking out subscriptions. The ticket is subsequently read by the mobile equipment 10. The local profile assistant (LPA) of the mobile equipment 10 obtains, from the network entity 11, the profile for access to the network via the limited connectivity provided by the initial profile. In this exemplary embodiment, the information request step E25, the reception step E26, the reply step E27 and the reception step E28 are not implemented. This simplifies the method for obtaining a profile for access to the network.

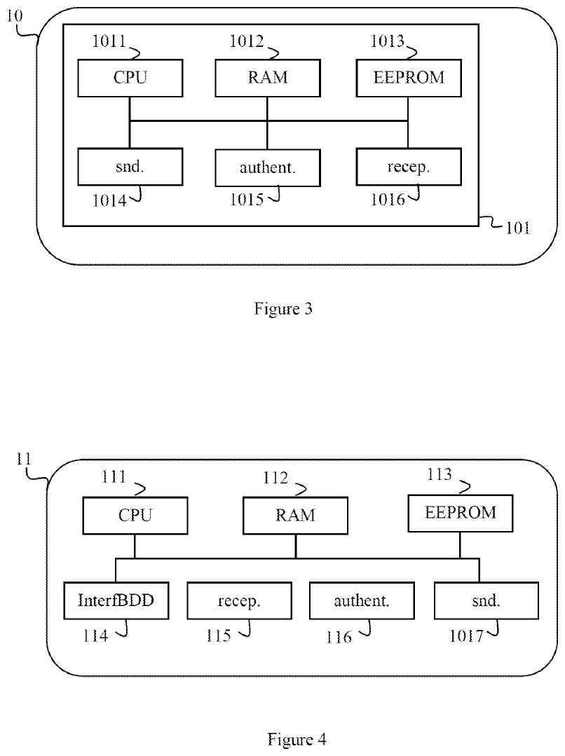

A mobile equipment 10, according to one exemplary embodiment, will now be described with reference to FIG. 3.

A mobile equipment 10 is for example a piece of user equipment such as a mobile terminal or a tablet. In another exemplary embodiment, the mobile equipment 10 is an M2M equipment. It should be noted that, in this case, it does not possess a user interface. In this case, it is associated with an M2M equipment fleet manager.

The mobile equipment 10 conventionally comprises a wireless interface configured for interfacing with a mobile communications network, a processor, a set of memories (these elements are not shown in FIG. 3) and a security module 101, for example an eUICC card. The security module 101 is configured for storing and for processing sensitive data, such as cryptographic keys and algorithms. Such data and algorithms are intended to be used to gain access to the mobile network. The interactions between the mobile terminal 10 and the security module 101 are very narrow and known. For the sake of readability, only elements forming part of the security module 101 are described hereinbelow and appear in FIG. 3.

Thus, in the security module 101, the mobile equipment 10 comprises:
a processing unit or processor 1011, or “CPU” (for “Central Processing Unit”), designed to load instructions into memory, to execute them, and to carry out operations;
a set of memories, including a volatile memory 1012, or “RAM” (for “Random Access Memory”) used for executing code instructions, storing variables, etc., and a storage memory 1013 of the “EEPROM” (for “Electrically Erasable Programmable Read Only Memory”) type. In particular, the storage memory 1103 is configured for storing a software module for obtaining a profile for access to a mobile network which comprises code instructions for implementing the steps of the method for obtaining a profile for access to the network such as previously described and which are implemented by the security module 101. The storage memory 1013 is also configured for storing a subscriber identifier of the IMSI type and a secret key K in a secure area. The subscriber identifier may be an initial identifier IMSIᵢₙᵢₜ and the secret key an initial secret key Kᵢₙᵢₜ, only designed to be used for a limited access to the network of the operator and intended for obtaining a permanent profile for access to the network from this operator. This initial data is intended to be replaced by a permanent identifier and secret key, obtained after taking out a subscription with the operator.

The mobile equipment 10 also comprises:
a transmission module 1014, configured for sending a request for access to the network, said request comprising an initial subscriber identifier IMSIᵢₙᵢₜ included in an initial profile. The transmission module 1014 is configured for implementing the steps E10 and E20 of the methods for obtaining a profile for access to the network previously described;
an authentication module 1015, configured for implementing a mutual authentication with the network entity 11 by means of the initial secret key Kᵢₙᵢₜ associated with the initial identifier IMSIᵢₙᵢₜ. The authentication module 1015 is configured for implementing the phases P14 and P24 of the methods for obtaining a profile for access to the network such as previously described;
a reception module 1016, configured for receiving a new profile for access to the network from the network entity 11, said new access profile comprising a new subscriber identifier and a new secret key. The new identifier and the new secret key are configured for accessing the network and the associated services of the operator as a client. The reception module 1016 is configured for implementing the steps E16 and E30 of the methods for obtaining a profile for access to the network such as previously described.

The transmission module 1014, the authentication module 1015 and the reception module 1016 are preferably software modules comprising software instructions for implementing the steps of the methods for obtaining a profile for access to a network such as previously described.

The invention therefore also relates to:
a computer program comprising instructions for the implementation of the methods for obtaining a profile for access to a network such as previously described when this program is executed by a processor of the mobile equipment,
a readable recording medium on which the computer program described hereinabove is recorded.

It should be noted that the invention is not limited to user equipment of this type and, in another exemplary embodiment, the mobile equipment 10 comprises a secure software area configured for processing the sensitive data for accessing the network.

A network equipment 11, according to one exemplary embodiment, will now be described with reference to FIG. 4.

The network equipment 11 is configured for receiving, from mobile equipments, requests for attachment to the network which comprise an initial identifier IMSIᵢₙᵢₜ, for implementing a mutual authentication with the mobile equipment on the basis of the initial identifier IMSIᵢₙᵢₜ and of an associated secret key Kᵢₙᵢₜ, for generating a new operational and permanent profile for access to the network and to the associated services for the user of the mobile equipment, said new profile comprising a new subscriber identifier and a new secret key, and for sending the new profile to the mobile equipment. The network equipment 11 is composed of one or more pieces of data processing equipment, such as computers.

The network equipment 11 comprises:
a processing unit or processor 111, designed to load instructions into memory, to execute them, and to carry out operations;
a set of memories, including a volatile memory 112 of the RAM type, used for executing code instructions, storing variables, etc., and a storage memory 113 of the EEPROM type. In particular, the storage memory 113 is configured for storing a software module for supplying a profile for access to a mobile network which comprises code instructions for implementing the steps of the method for obtaining a profile for access to the network which are implemented by the network equipment 11;
interfaces 114 for accessing databases, such as a partner database comprising initial identifiers and associated initial secret keys and a database of subscriber identifiers and of associated secret keys.

The network equipment 11 also comprises:
a reception module 115, configured for receiving from a mobile equipment a request for accessing the network, said request comprising an initial subscriber identifier IMSIᵢₙᵢₜ included in an initial profile. The reception module 116 is configured for implementing the steps E11 and E21 of the methods for obtaining a profile for access to a mobile network such as previously described;
a mutual authentication module 116, configured for implementing a mutual authentication with the mobile equipment by means of an initial secret key Kᵢₙᵢₜ associated with the initial identifier. The mutual authentication module 116 is configured for implementing the phases P14 and P24 of the methods for obtaining a profile for access to a mobile network such as previously described;
a module 117 for sending, to the mobile equipment, a new profile for access to the network, said new access profile comprising a new subscriber identifier and a new secret key, said new profile being configured for accessing said network. The module 117 for sending a new profile is configured for implementing the steps E15 and E29 of the methods for obtaining a profile for access to a mobile network such as previously described. The module 117 for sending a new access profile interfaces with a profile generation module (not shown in FIG. 4), configured for generating the new profiles for subscription to the network. In one exemplary embodiment where the subscription has not been taken out prior to the implementation of the methods for obtaining a profile for access to the network, the profile generation module offers an interface which may be accessed by the user in order for the latter to supply their subscription data.

The reception module 115, authentication module 116 and module 117 for sending a new profile are preferably software modules comprising software instructions for implementing the steps of the methods for obtaining a profile for access to a network such as previously described and which are implemented by the network equipment 11.

The invention therefore also relates to:
a computer program comprising instructions for the implementation of the methods for obtaining a profile for access to a network such as previously described when this program is executed by a processor of the network equipment 11,
a readable recording medium on which the computer program described hereinabove is recorded.

The invention also relates to a system for distributing profiles for accessing a telecommunications network comprising:
a network equipment such as previously described, and
at least one mobile equipment such as previously described.

Although the present disclosure has been described with reference to one or more examples, workers skilled in the art will recognize that changes may be made in form and detail without departing from the scope of the disclosure and/or the appended claims.

1. A method for obtaining a profile for access to a telecommunications network by a mobile equipment, the method comprising:
sending by the mobile equipment to a network entity a request for accessing said network, said request comprising an initial subscriber identifier included in an initial profile,
mutual authentication between the mobile equipment and the network entity by using an initial secret key associated with the initial identifier, and
receiving from the network entity a new profile for access to said network, said new access profile comprising a new subscriber identifier and a new secret key, said new profile being configured for accessing said network.

2. The method as claimed in claim 1, comprising, when no subscription has previously been taken out by a user of the mobile equipment with an operator associated with the network entity:
receiving a message, said message comprising the address of a site of the operator, said site being dedicated to taking out subscriptions,
accessing the site and taking out a subscription with the operator associated with the network entity, said subscription being used by the operator to generate the access profile.

3. The method as claimed in claim 1, comprising, when no subscription has previously been taken out by a user of the mobile equipment with an operator associated with the network entity:
receiving a telephone call from the operator,
taking out a subscription with the operator associated with the network entity, said subscription being used by the operator to generate the access profile.

4. The method as claimed in claim 1, in which the initial identifier comprises at least one field representative of an access limited to the acquisition of a profile for access to the network.

5. The method as claimed in claim 1, in which the initial identifier is read by using the mobile equipment on a ticket supplied by the operator, said ticket comprising an identifier of a security module included in the mobile equipment.

6. A method for supplying a profile for access to a telecommunications network by a network entity to a mobile equipment, the method comprising:
receiving from the mobile equipment a request for access to the network, said request comprising an initial subscriber identifier included in an initial profile,
mutual authentication between the network entity and the mobile equipment by using an initial secret key associated with the initial identifier, and
sending to the mobile equipment a new profile for access to the network, said new access profile comprising a new subscriber identifier and a new secret key, said new profile being configured for accessing said network.

7. A mobile equipment comprising:
transmission means, configured for sending a request for access to the network, said request comprising an initial subscriber identifier included in an initial profile,
authentication means, configured for implementing a mutual authentication with the network entity by using an initial secret key associated with the initial identifier, and
reception means, configured for receiving from the network entity a new profile for access to the network, said new access profile comprising a new subscriber identifier and a new secret key, said new profile being configured for accessing said network.

8. (canceled)

9. A non-transitory computer-readable data medium comprising program code instructions stored thereon, which when executed by a processor of a mobile equipment, configure the mobile equipment to obtain a profile for access to a telecommunications network by:
sending by the mobile equipment to a network entity a request for accessing said network, said request comprising an initial subscriber identifier included in an initial profile,
mutual authentication between the mobile equipment and the network entity by using an initial secret key associated with the initial identifier, and
receiving from the network entity a new profile for access to said network, said new access profile comprising a new subscriber identifier and a new secret key, said new profile being configured for accessing said network.

10. A network equipment of a telecommunications network,
configured for supplying a profile for accessing the network to a mobile equipment, said network equipment comprising:
reception means, configured for receiving from the mobile equipment a request for access to the network, said request comprising an initial subscriber identifier included in an initial profile,
authentication means, configured for implementing a mutual authentication with the mobile equipment by means of an initial secret key associated with the initial identifier, and
transmission means, configured for sending a new profile for access to the network to the mobile equipment, said new access profile comprising a new subscriber identifier and a new secret key, said new profile being configured for accessing said network.

11. (canceled)

12. A non-transitory computer-readable data medium comprising program code instructions stored thereon, which when executed by a processor of a network entity, configure the network entity to supply a profile for access to a telecommunications network to a mobile equipment by:
receiving from the mobile equipment a request for access to the network, said request comprising an initial subscriber identifier included in an initial profile,
mutual authentication between the network entity and the mobile equipment by using an initial secret key associated with the initial identifier, and
sending to the mobile equipment a new profile for access to the network, said new access profile comprising a new subscriber identifier and a new secret key, said new profile being configured for accessing said network.

13. (canceled)
